(19) United States
(12) Patent Application Publication
(10) Pub. No.: US 2007/0050302 A1
(43) Pub. Date: Mar. 1, 2007

(54) Method for calculating the economic profitability of power transformers and method for the optimization of the economic profitability of power transformers

(76) Inventors: Luiz Americo Venturini Cheim, Itatiba (BR); Jose Geraldo Gervino Silveira, Jundiai (BR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/210,882

(22) Filed: Aug. 25, 2005

(51) Int. Cl. G06Q 99/00

(52) U.S. Cl. 705/63

(57) ABSTRACT

A method for calculating the economic profitability of power transformers through standardized parameters, economical parameters, technical data from the power transformers and data from the initial investments is disclosed, said method for calculating the economic profitability of power transformers comprising:

a) calculating the total ownership cost (TOC) of the power transformer as a function of a depreciation period (40); b) calculating the revenue of the power transformer in a total investment to meet a determined demand; and c) use of the revenue of the power transformer and of the total ownership cost (TOC) of the power transformer to determine the total economic profitability of the power transformer. A method for the optimization of the economic profitability of power transformers is further disclosed, comprising the steps of: (i) obtaining a first power transformer, using this first power transformer operating at limits close to the maximal load and raising the temperature at the hot spot limits during a first minimal limit of depreciation period; (ii) obtaining a first period of optimized annual returns; (iii) obtaining a second power transformer, using this second power transformer operating at limits close to the maximal load and raising the temperature at the hot spot limits during a first minimal limit of depreciation period; (iv) obtaining a second period of optimized annual returns; (v) repairing the first power transformer, using this first repaired power transformer operating at maximal load and raising temperature at the hot spot limits during a second minimal depreciation period limit; (vi) obtaining a third of period of maximal annual returns; (vii) repairing the second power transformer, using this second repaired power transformer operating at maximal load and raising temperature at the hot spot limits during a second minimal depreciation period limit; (viii) obtaining a fourth period of maximal annual returns; and (ix) selling the first and second power transformers.

The present invention refers to a method for the calculation of the economic profitability of power transformers and to a method for the optimization of the economic profitability of power transformers, from a mathematical model used in processes of simulation of the depreciation and lifetime of power transformers, optimizing the operation of such transformers and reducing costs with maintenance planning and execution.

### DESCRIPTION OF THE STATE OF THE ART

Through international standards (ABNT—Brazilian Association of Technical Standards, IEEE-ANSI/USA—The Institute of Electrical and Electronics Engineers, Incorporated/American National Standards Institute, IEC—International Engineering Consortium, among others) it is determined that the life expectancy of a power transformer is associated to the equivalent temperature of operation at the hot spot. Thus, depending on the used standard, there is the value of the temperature of operation at the hot spot, and, with this data, the expected lifetime of the transformer can be achieved. This temperature varies cyclically with the load and with the very room temperature at the place in which the transformer is installed.

Although systems for the monitoring and controlling of the operation conditions of a power transformer, in which determined parameters of the transformer in operation are constantly stored, are already know in the state of the art, it is not know, up to now, a developed mathematical model able to associate parameters involved in the operation of power transformers (such as: power, loss factor, maximal temperature at the hot spot, variation of room temperature, depreciation, among many others), aiming at calculating and simulating the financial return that a company would have due to the lifetime of said transformer, neither at calculating nor simulating ways for optimizing this financial return.

Thus, nowadays the lifetime period of a power transformer is established as a function of the stipulated data in the used standard and the financial return with this transformer is calculated in such a way that it follows this established lifetime period. The monitoring and maintenance of this transformer are carried out so that it reaches the stipulated lifetime period thus assuring the financial return of the initial investment. Thus, it is not possible to simulate the cost/benefit of this transformer to the company, if it operates at different conditions in load, temperatures, power, etc. That is, there are no mathematical methods that simulate and forecast the value of the financial return of a determined power transformer in multiple conditions diverse from the ones stipulated in the standard, neither can it be found in the state of the art mathematical models able to calculate the effects over an expected financial return for a power transformer, if it is programmed to work on overload.

### OBJECTIVES OF THE INVENTION

The present invention aims at providing a method for the calculation of the profitability or revenue of power transformers for meeting with a determined demand, taking into consideration diverse variable parameters, such as: power, load factor, maximal temperature at the hot spot, variation of the room temperature, among others.

It is a further objective of the present invention to provide a method for the calculation and simulation of possible effects over the financial return or revenue of power transformers, when these are programmed to work on overload and with other types of variation of the standardized parameters.

This invention has as a further objective to provide a method for the optimization of the economic profitability of power transformers, enabling the calculation and/or simulation of several ways of using one or more power transformers, aiming at obtaining the initial financial return in a short period of time in relation to the time stipulated by the standards.

### BRIEF DESCRIPTION OF THE INVENTION

The invention has as its object a method for calculating the economic profitability of power transformers through standardized parameters, economical parameters, technical data from the power transformers and data from the initial investments, said method for calculating the economic profitability of power transformers comprising:

a) calculating the total ownership cost (TOC) of the power transformer as a function of a depreciation period;

b) calculating the revenue of the power transformer in a total investment to meet a determined demand; and

c) use of the revenue of the power transformer and of the total ownership cost (TOC) of the power transformer to determine the total economic profitability of the power transformer.

It is a further object of the present invention a method for the optimization of the economic profitability of power transformers, comprising the steps of:
(i) obtaining a first power transformer, using this first power transformer operating at maximal load and raising the temperature at the hot spot limits during a first minimal limit of depreciation period;
(ii) obtaining a first power transformer, using this first power transformer operating at limits close to the maximal load and raising the temperature at the hot spot limits during a first minimal limit of depreciation period;
(iii) obtaining a first period of optimized annual returns;
(iv) obtaining a second power transformer, using this second power transformer operating at limits close to the maximal load and raising the temperature at the hot spot limits during a first minimal limit of depreciation period;
(v) obtaining a second period of optimized annual returns;
(vi) repairing the first power transformer, using this first repaired power transformer operating at maximal load and raising temperature at the hot spot limits during a second minimal depreciation period limit;
(vii) obtaining a third of period of maximal annual returns;
(viii) repairing the second power transformer, using this second repaired power transformer operating at maximal load and raising temperature at the hot spot limits during a second minimal depreciation period limit;
(ix) obtaining a fourth period of maximal annual returns; and
(x) selling the first and second power transformers.

### BRIEF DESCRIPTION OF THE DRAWINGS

The present invention will be as follows described in more detail based on an embodiment example represented in the drawings. The figures show:

FIG. 1—illustrates a graph that correlates the maximal admissible temperature at the hot spot and the life expectancy of a power transformer;

FIG. 2—illustrates a spreadsheet that composes the method for the calculation of the economic profitability of power transformers, object of this invention;

FIG. 3—is a block diagram related to the spreadsheet illustrated in FIG. 2;

FIG. 4—is a block diagram related to the spreadsheet illustrated in FIG. 2; and

FIG. 5—illustrates a comparative chart related to the method for the optimization of the economic profitability of power transformers, object of the present invention.

### DETAILED DESCRIPTION OF THE FIGURES

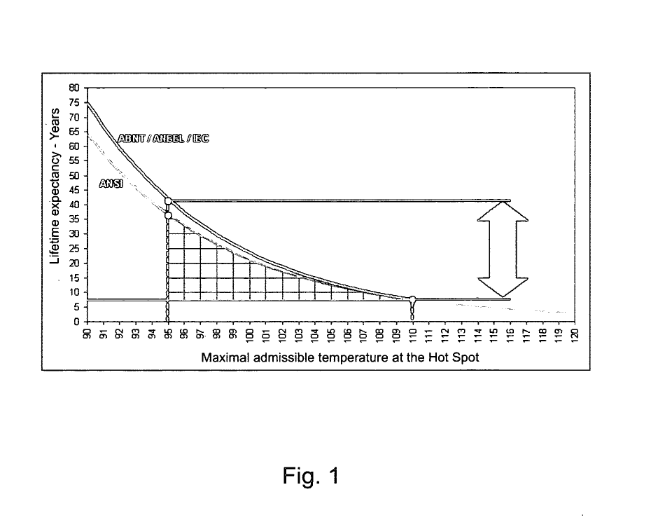

FIG. 1 illustrates a graph that correlates the maximal admissible temperature at the hot spot and the lifetime expectancy of a power transformer. As can be seen in this graph, the higher the temperature at the hot spot, the lower the life expectancy will be, independently of the considered standard (ABNT, ANSI, IEC, among others).

Thus, for a transformer to have a life expectancy of forty years, the equivalent maximal admissible temperature at the hot spot is 95° C. On the other hand, if it is desired for the transformer to have a lifetime of only seven and a half years (more precisely 7.42 years) then this equivalent maximal admissible temperature at the hot spot can reach 110° C. and so forth.

Generally, it is established that the lifetime expectancy of a power transformer should be around forty years. In this case, the electrical power utility company must make an investment to acquire the transformer, keep it along these forty years, calculate the depreciation of the value of this asset, pay interest over the loan made to acquire the asset, run an operational risk (for example, of not meeting the demand in case of failure of the equipment) and, additionally, have some kind of financial return for the fact of being meeting the power demand when it installs the transformer at some substation or electrical power plant.

Thus, it is necessary for the company to have conditions to analyze, under the financial point of view, what is the economical impact of this transformer, associated to the type of operation to which it is subjected. Only then it will be possible to verify, with more precision, if the established lifetime expectancy (around forty years) is advantageous.

Thus, according to a preferred embodiment and as can be seen from FIG. 1, the method for the calculation of the economic profitability of power transformers, object of this invention comprises:

a) calculating the total ownership cost (TOC) of the power transformer as a function of a depreciation period 40;

b) calculating the revenue of the power transformer in a total investment to meet a determined demand; and

c) use of the revenue of the power transformer and of the total ownership cost (TOC) of the power transformer to determine the total economic profitability of the power transformer.

These calculations and determinations are made by computational means or software that process input data executing mathematical models and obtaining output information. That means that this software has the function of correlating multiple technical and economical parameters relating to the power transformer, and calculating the financial return that the company or utility company would have, as a function of the lifetime expectancy or desired depreciation of this transformer.

For financial return it can be understood the recovery the global investment made for meeting with a determined power demand.

Therefore, the method for the calculation of the present invention is based on the following accounting equation:
Result=Revenue−TOC (equation 1)
Where:
TOC—represents the Total Ownership Cost, the cost of the utility company at the acquisition of the power transformer and at the maintenance thereof, in order for this equipment to last the lifetime expectancy period previously defined. In this item is its taken into consideration the monetary devaluing and the depreciation of the asset, as will be described in more detailed as follows; and
Revenue—or remuneration of the transformer that represents the portion of representativeness of the power transformer in the global investment made by the utility company to meet a determined demand in the global financial return that the company has when meets this very demand.

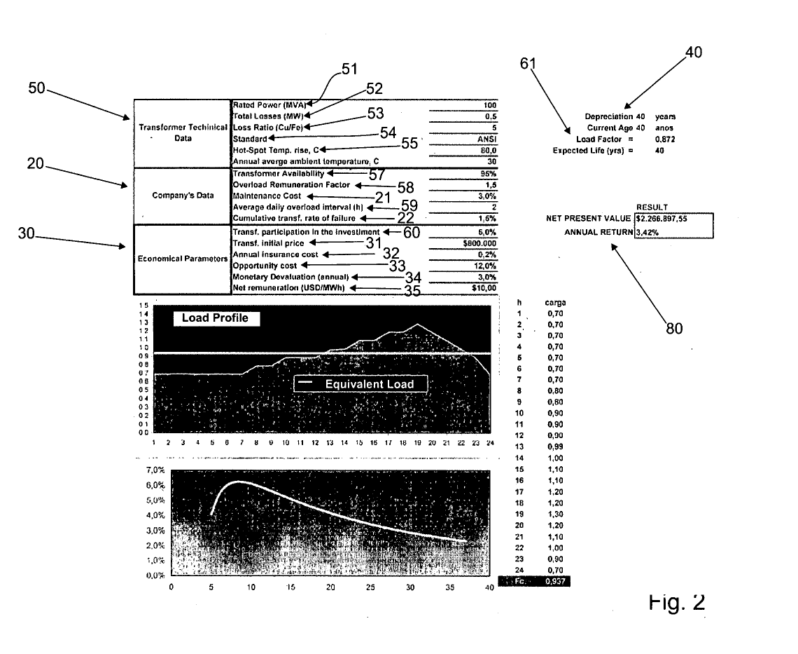

Such calculations and simulations are illustrated by means of spreadsheets, as illustrated in FIG. 2, through which the user is able to obtain information by means of actual data or simulate, forecast hypothetical situations of use of a power transformer.

In this FIG. 2, the spreadsheet presents in divisions defined as an example of a preferred embodiment, the multiple parameters used by the present method for calculating or simulating the economic profitability of power transformers using the above mentioned equation 1.

Total Ownership Cost

The calculation of the total ownership cost of the power transformer (TOC), described in step “a” of the present method, is carried out from maintenance parameters 20, economical parameters 30 and as a function of the depreciation period 40.

The maintenance parameters 20 comprise: maintenance cost factor 21 and failure risk factor 22.

The maintenance cost factor 21, conservatively, is taken as a fixed factor, and represents an estimative of the costs that the company will have with eventual interruptions in the operation of the transformer for the preventive as well as corrective repairing thereof, along the lifetime of this transformer as a percentage.

The failure risk factor 22 is defined as an annual “cost”, associated to the probability of failure of the transformer, which also increases annually. Thus, the failure risk 22 is defined by the equation 2 below:

Failure risk=failure cost×probability of failure, the failure probability being defined as (1−reliability).
Failure risk=failure cost(1−e^{-λ×t}) (equation 2)

Where:

λ=average accumulated rate of failure of the transformers (typically of about 1.5 to 3% per year).

t=time of operation in years.

Regarding the failure cost, it can be:

a) Conservative: when it refers to the cost of replacing the failed transformer by a new one; or

b) Aggressive: when it refers to the cost of replacing the failed transformed by a new one, considering costs of not meeting the demand and to the cost involved in the acquisition/operation of the equipment, including eventual damage to the environment and to human beings that may be working next to the transformer, at the moment of failure.

The economical parameters 30 comprise:

an initial cost for obtaining the transformer 31, that is, the value disbursed by the utility company in the acquisition of the new power transformer;

an annual insurance factor 32;

an alternative opportunities cost factor 33, that means an estimative of how much the company or utility company would be obtaining of financial return, if it had employed the money of the acquisition of the transformer in the financial market, for example, in income funds, stocks, etc.

a monetary devaluation cost factor 34, inherent to long term financings; and

a net remuneration factor 35 for the meeting of the power demand by the transformer, that is, the difference between what the company pays to generate (or buy) power, on one hand, and by what the company receives from the consumer when meeting the demand.

Finally, the depreciation period 40 has a great and important influence over the time for which the transformer should last so that the initial investment is recovered. The total return varies as a function of the depreciation period 40.

Revenue Obtained by the Transformer

The calculation of the revenue as referred in step “b” of the present method is performed from technical parameters 50 of the power transformer, which subdivide in specific technical parameters and operational parameters of the company, as described as follows.

The technical parameters 50 comprise:
Specific technical parameters of the transformer:

a power factor of the transformer 51 which is the capacity of the power transformer;

a total loss factor of the transformer 52, measured in laboratory and specific for each power transformer;

a material loss factor in the transformer 53, which consists on the relation of losses in copper and losses in iron (Cu/Fe), construction materials of the transformer.

The total loss of the transformer 52 as well as the material loss of the transformer 53 are important in proportion to their impact on the efficiency of the transformer in function of the load. Increasing the load of a power transformer also increases the losses thereof.

It is noted then that these three first factors are specific to each power transformer.

a standard factor 54—depending on the used standard the utilization of the technical factors of the transformer may be different;

a raise of the maximal admissible temperature at the hot spot factor 55, obtained by laboratory essays or through the used standard, for example, the IEC or IEEE/ANSI or ABNT standard determines that the maximal raise of the temperature at the hot spot, in relation to the room temperature is of up to 80° C., that is, if the average room temperature is 30° C., the maximal temperature at the hot spot, according to these standards corresponds to 110° C.

a room temperature factor 56, that as mentioned above, is a cause of influence over the raise of the maximal admissible temperature factor;

a load factor 61, that corresponds to how much of the namely capacity is being used to meet the demand per hundred, that is, the equivalent load of a power transformer along the day considering periods with the lowest requests and peak periods in the use of the transformer.

It is worthwhile to stress that these temperature values may be obtained in the standards or may be calculated through the equivalent load of the transformer (average load of the transformer along the day). In function of the equivalent load by the standard equations (not illustrated), it is possible to calculate the raise temperatures at the hot spot 55 and room temperature 56, by mathematical models.

Therefore, as a function of the load and of the temperatures it is calculated the relative aging or lifetime expectancy of the transformer. Thus, if a lifetime of forty years is stipulated for a transformer the equivalent load thereof or, in this case, the load factor 61 has to be such that it conducts to an equivalent temperature (raise of the maximal admissible temperature at the hot spot factor 55) pertinent for this duration period of the transformer. That means that the load factor 61 is limited to a value that is able to conduct the transformer to the lifetime expectancy determined thereto.
Operational parameters of the specific company or of the place where the transformer is installed:

a utilization factor of the transformer 57, which demonstrates, in percentage, how long the transformer remains energized considering 24 hours of 365 days of the year;

an overload remuneration factor 58—equivalent to how much the utility company receives more to meet the electrical power demand peaks, above the normal conditions of the equipment.

an average time factor of annual overload 59; and

participation of the transformer in the investment factor 60, that is, the participation of the transformer in the global investment made to meet a determined demand.

This factor is important, in a sense that the global investment made to meet a determined power demand does not consist only of the acquisition and installation of the transformer. Although the transformer is an essential part and its value is significant there are also the other equipments necessary at the substation for meeting the demand.

Results

Still in relation to the spreadsheet, as illustrated in FIG. 2, once the factors of the parameters as described above are stipulated, the annual return 80 is obtained, that is the financial return that the utility company will obtain annually, using the power transformer in the informed conditions for meeting the stipulated demand.

Thus, by means of the present method for the calculation of the economic profitability of power transformers, using this spreadsheet several situations of use of a power transformer can be determined and simulated, always obtaining the annual financial return that such conditions will provide to the utility company.

The use of the calculation method of the present invention by means of this spreadsheet illustrated in FIG. 2 consists on inputting data of the maintenance parameters 20, economical parameters 30, technical parameters and, mainly, stipulating the depreciation period 40. Automatically, by means of computational and software resources, the calculation of the annual return 80 is made. So, to know the annual return 80 of a power transformer, keeping all the parameters unaltered, however changing the depreciation period, it is only necessary to alter the field reserved to the data of the depreciation period 40 in this spreadsheet and verify the calculated and demonstrated alteration of the load factor 61 and of the annual return 80.

That is due to, as mentioned beforehand, the lifetime of a power transformer depending on the load to which said transformer is submitted to, of the room temperature at the place where said transformer is installed and of the construction project of said transformer. Thus, modifying the depreciation period 40 and keeping constant the remaining factors the load factor 61 which should be reached for the durability of said transformer corresponds to the value of the depreciation period 40 that is desired can be determined, as well as the annual return 80 that said transformer, working at a load factor 61 much higher will provide to the utility company.

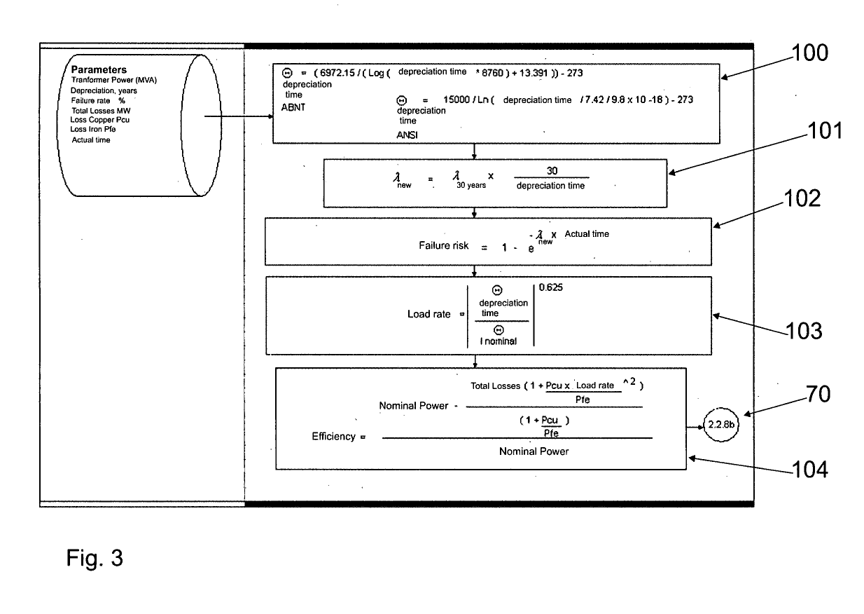

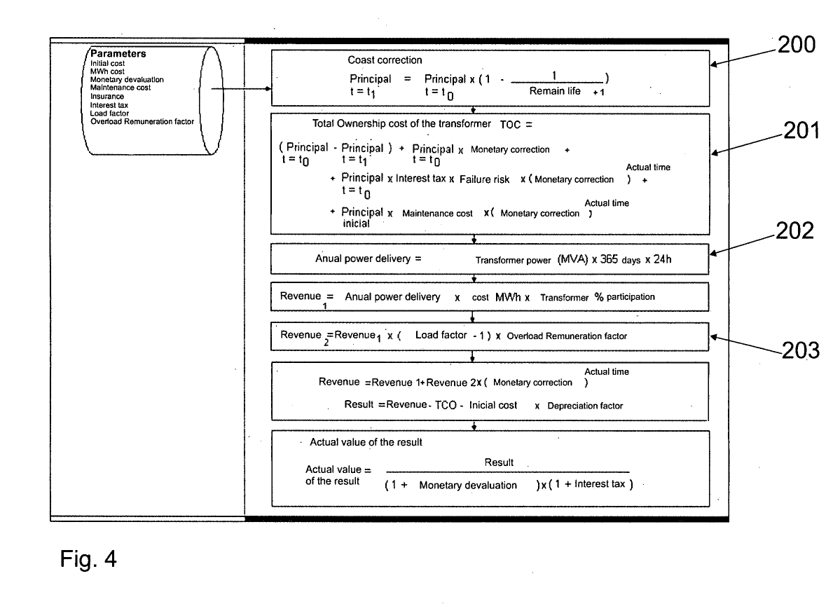

The most significant calculations for the use of this spreadsheet of the calculation method of the present invention are illustrated in FIGS. 3 and 4 and will be discussed as follows.

As can be seen in first block diagram illustrated in FIG. 3, initially, part of the technical parameters 50 are worked so that a first result 70 can be obtained. In this case, the power factor 51 of the transformer, the total loss factor 52 of the transformer, the material loss factor 53 of the transformer, the standard factor 54, the depreciation factor 40 and a failure rate are applied in successive specific equations, among them the equation for the calculation of the failure risk (equation 2) and an equation of the efficiency of the transformer, so that these factors are associated and a first partial result 70 is obtained.

Following that, as is demonstrated in the second block diagram illustrated in FIG. 4, the maintenance parameters and the economical parameters 30 inserted into the spreadsheet are used in order to complement the first partial result 70 obtained and to finalize the calculation of the economic profitability of power transformers at which the method of the present invention is aimed.

In this diagram, specific secondary equations, related to the monetary correction 200, to the Total Ownership Cost (TOC) 201 itself, to the utilization of the transformer 202, to the total revenue or profitability of the transformer 203 are applied aiming at relating to the several factors involved, make them uniform and distribute them in the already described equation 1.

The result of the equation 1 is the return that is desired to know, and that is demonstrated in the spreadsheet as a percentage as annual return 80, for which this method for the calculation of the economic profitability of power transformers is aimed at, object of the present invention.

Thus, the present model of calculation demonstrates that not always the higher financial return, annual return 80, occurs when the lifetime of the power transformer is of about 40 years, as ABNT suggests. In some cases, the model for the calculation demonstrates that it is more advantageous, under the economical and financial point of view to operate the transformer at a higher load, with a raise in the maximal temperature at the hot spot at the maximal limit of the standard and for a shorter period of time (for example, about 15 years). On account of that, the model for the calculation object of the present invention brings innovative and surprising results in relation to the best way of operating a transformer to obtain a higher financial return.

However, the increase in the load factor of the transformer and the consequent reduction of the lifetime thereof, although generate a very high annual return 89, may not be interesting to an utility company that has a long term goal planning and that, in this case, the ideal would be to obtain the same high annual return 80, with a longer period of use of the power transformer.

Therefore, the present invention has a further object an optimization method of the economic profitability of power transformers.

This optimization process uses the method for the calculation of the economic profitability of power transformers, as described hereinabove, and consists in the steps of:

(i) obtaining a first power transformer, using this first power transformer operating at maximal load and raising the temperature at the hot spot limits during a first minimal limit of depreciation period;

(ii) obtaining a first period of optimized annual returns;

(iii) obtaining a second power transformer, using this second power transformer operating at limits close to the maximal load and raising the temperature at the hot spot limits during a first minimal limit of depreciation period;

(iv) obtaining a second period of optimized annual returns;

(v) repairing the first power transformer, using this first repaired power transformer operating at maximal load and raising temperature at the hot spot limits during a second minimal depreciation period limit;

(vi) obtaining a third of period of maximal annual returns;

(vii) repairing the second power transformer, using this second repaired power transformer operating at maximal load and raising temperature at the hot spot limits during a second minimal depreciation period limit;

(viii) obtaining a fourth period of maximal annual returns; and

(ix) selling the first and second power transformers.

For this method for the optimization of the economic profitability of power transformers, the determination of maximal and minimal limits of technical parameters 50 and economical parameters 30 for the operations of the power transformers, that is, the determination of the factors of maximal load factors, maximal temperature elevation factors at the hot spot and of the minimal depreciation period are made through the calculation method of the economic profitability of power transformers, using the spreadsheet as illustrated in FIG. 2 and the remaining equations 1 and 2 already discussed beforehand.

Thus, the optimization proposed by this optimization method is in the use of one or more power transformers, operating at their maximal solicitation limits and for minimal lifetime periods, obtaining, as result, maximal annual financial returns.

As a comparison, using the present method of the optimization of the economic profitability of power transformers, the annual return 80 obtained through the use of one only power transformer for the maximal depreciation period stipulated by the standard is considerably smaller than the financial return obtained through the use of at least two power transformers, operationally exploited as determined by the present optimization method.

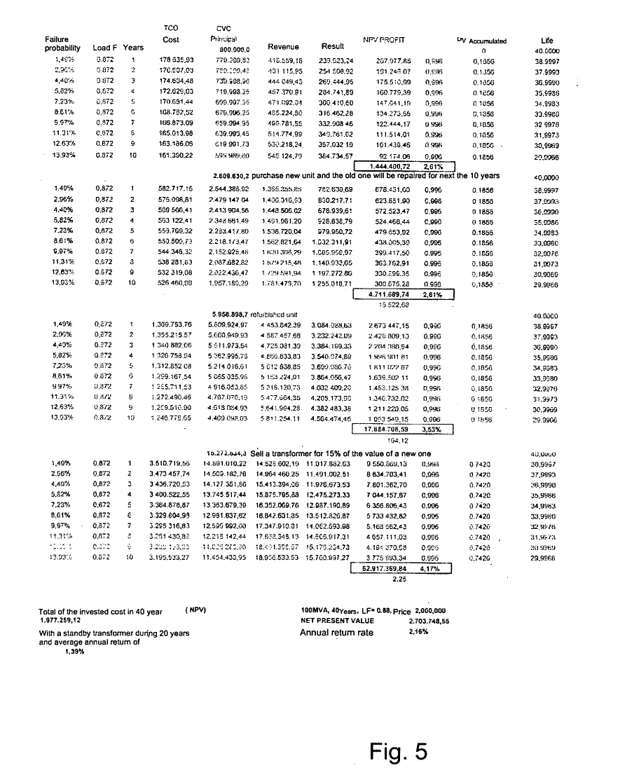

A comparative chart representing the profitability of power transformers used as the proposed optimization method is illustrated in FIG. 5.

Keeping the factors demonstrated in the spreadsheet illustrated in FIG. 2, the average profitability of a power transformer used for forty years, as established in standard is of 3.42% while using the optimization method described hereinabove by the end of 40 years the two transformers operating with maximal factors provide an average profitability of 11.87%. In both cases, the final results already consider TOC.

Although the method for the optimization of economic profitability of power transformers has been disclosed, using as example two transformers it is possible the use of as many transformers as desired.

Further, the disposition of the parameters in the cost spreadsheet illustrated in FIG. 2 can be made in many other ways as long as the functionality is kept.

The preferred embodiment having been disclosed, it must be understood that the scope of the present invention encompasses other possible variations being limited only by the content of the appended claims, there included possible equivalents.

1. Method for calculating the economic profitability of power transformers through standardized parameters, economical parameters, technical data from the power transformers and data from the initial investments, said method for calculating the economic profitability of power transformers wherein it comprises the steps of:
a) calculating the total ownership cost (TOC) of the power transformer as a function of a depreciation period (40);
b) calculating the revenue of the power transformer in a total investment to meet a determined demand; and
c) use of the revenue of the power transformer and of the total ownership cost (TOC) of the power transformer to determine the total economic profitability of the power transformer.

2. Method, according to claim 1, wherein it consists of a software that processes input data, executing mathematical models and obtaining output information.

3. Method, according to claim 2, wherein before step (a) there occurs the input data insertion in a spreadsheet.

4. Method, according to claim 3, wherein the calculation of the total ownership cost (TOC) of the power transformer is made from maintenance parameters (20), economical parameters (30) and depreciation period (40).

5. Method, according to claim 4, wherein the maintenance parameters (20) comprise a maintenance cost factor (21) and a failure risk factor (22).

6. Method, according to claim 5, wherein the maintenance cost factor (21) is a fixed factor that represents cost estimation of the cost with interruptions in the operations of the power transformer.

7. Method, according to claim 6, wherein the failure risk (22) consists if an annual cost associated with a probability of increasing failure annually.

8. Method, according to claim 4, wherein the economical parameters (30) comprise an initial cost with the acquisition of the transformer (31), an annual insurance factor (32), an alternative opportunities cost factor (33), an monetary devaluation cost factor (34) and a net remuneration factor (35).

9. Method, according to claim 8, wherein the alternative opportunities cost factor (33) consists of an estimation of an equivalent financial return obtained in a financial market for the acquisition cost of the transformer (31).

10. Method, according to claim 1, wherein the calculation of the revenue of the power transformer in a total investment to meet a determined demand is made from technical parameters (50) of the power transformer.

11. Method, according to claim 10, wherein the technical parameters (50) comprise a transformer power factor (51), a total loss of the transformer factor (52), a loss in the material of the transformer factor (53), a standard factor (54), a maximal admissible temperature at the hot spot factor (55), a room temperature factor (56), a utilization of the transformer factor (57), an overload remuneration factor (58), an average time of annual overload (59), an participation of the transformer in the investment factor (60) and a load factor (61).

12. Method, according to claim 11, wherein the raise of the maximal admissible temperature at the hot spot factor (55) is obtained by means of laboratory essays or through a technical standard, this raising the maximal admissible temperature at the hot spot factor (55) consisting of a maximal raising the temperature at the hot spot in relation to a room temperature.

13. Method, according to claim 12, wherein the participation of the transformer in the investment factor (60) consists of a participation of the transformer in the global investment in relation to a demand.

14. Method, according to claims 2, wherein the output information consists of annual return data (80).

15. Method for the optimization of the economic profitability of power transformers, wherein it comprises the following steps:
(i) obtaining a first power transformer, using this first power transformer operating at limits close to the maximal load and raising the temperature at the hot spot limits during a first minimal limit of depreciation period;
(ii) obtaining a first period of optimized annual returns;
(iii) obtaining a second power transformer, using this second power transformer operating at limits close to the maximal load and raising the temperature at the hot spot limits during a first minimal limit of depreciation period;
(iv) obtaining a second period of optimized annual returns;
(v) repairing the first power transformer, using this first repaired power transformer operating at maximal load and raising temperature at the hot spot limits during a second minimal depreciation period limit;
(vi) obtaining a third of period of maximal annual returns;
(vii) repairing the second power transformer, using this second repaired power transformer operating at maximal load and raising temperature at the hot spot limits during a second minimal depreciation period limit;
(viii) obtaining a fourth period of maximal annual returns; and
(ix) selling the first and second power transformers.
